(19) United States
(12) Patent Application Publication
(10) Pub. No.: US 2014/0176114 A1
(43) Pub. Date: Jun. 26, 2014

(54) TIME SEQUENCE CIRCUIT FOR POWER SUPPLY UNIT

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: HAI-QING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/141,389

(22) Filed: Dec. 26, 2013

(30) Foreign Application Priority Data
Dec. 26, 2012 (CN) 2012105709250

(51) Int. Cl. G06F 1/32

(52) U.S. Cl. CPC G06F 1/3296
USPC 323/350

(57) ABSTRACT

A time sequence circuit for a power supply unit includes first through tenth resistors, first and second electronic switches, first through fourth diodes, and a capacitor. Each of the first and second electronic switches includes first through third terminals. When the power supply unit outputs all voltages, the power supply unit outputs a high-voltage level power good signal. If one of the voltages is not outputted, the power supply unit outputs a low-voltage level power good signal.

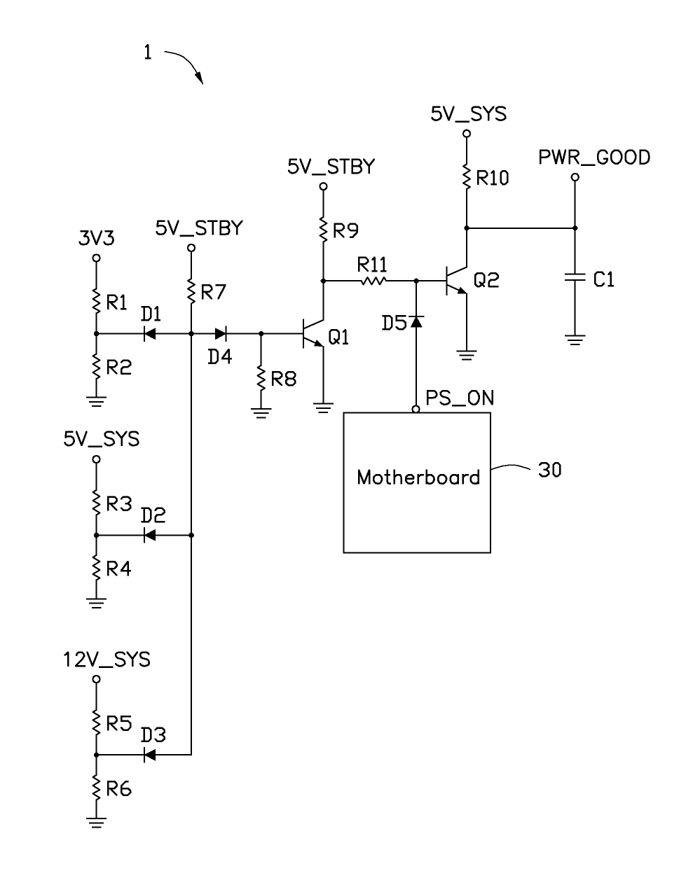

### BACKGROUND

1. Technical Field

The present disclosure relates to a time sequence circuit for a power supply unit.

2. Description of Related Art

During a power-on operation of a computer, a motherboard of the computer may change a power-on signal PS_ON from a high-voltage level to a low-voltage level. When a power supply unit receives the low-voltage level power-on signal PS_ON, the power supply unit outputs different voltages, such as 3V3, 5V_SYS, 5V_STBY, and 12V_SYS voltages, at the same time. When all the different voltages are outputted, the power supply unit further outputs a high-voltage level power good signal after 100-500 milliseconds, and then the computer can start up. However, a user may use different types of power supply units, which may cause a time sequence of the power supply unit to be unsuitable for the motherboard.

Therefore, there is room for improvement in the art.

### BRIEF DESCRIPTION OF THE DRAWING

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

The FIGURE is a circuit diagram of an embodiment of a time sequence circuit for a power supply unit.

### DETAILED DESCRIPTION

The disclosure is illustrated by way of example and not by way of limitation in the FIGURES of the accompanying drawings in which like references indicate similar elements. It should be noted that references to “an” or “one” embodiment in this disclosure are not necessarily to the same embodiment, and such references mean “at least one.”

The FIGURE illustrates an embodiment of a time sequence circuit for a power supply unit 1. The time sequence circuit comprises eleven resistors R1-R11, two BJT transistors Q1 and Q2, five diodes D1-D5, and a capacitor C1.

A cathode of the diode D1 is coupled to a system power terminal 3V3 through the resistor R1, and is connected to ground through the resistor R2. An anode of the diode D1 is coupled to a stand-by power terminal 5V_STBY through the resistor R7, and is also coupled to an anode of the diode D4. A cathode of the diode D2 is coupled to a system power terminal 5V_SYS through the resistor R3, and is connected to ground through the resistor R4. An anode of the diode D2 is coupled to the anode of the diode D4. A cathode of the diode D3 is coupled to a system power terminal 12V_SYS through the resistor R5, and is connected to ground through the resistor R6. An anode of the diode D3 is coupled to the anode of the diode D2. A cathode of the diode D4 is connected to ground through the resistor R8, and is coupled to a base of the transistor Q1. An emitter of the transistor Q1 is connected to ground. A collector of the transistor Q1 is coupled to the stand-by power terminal 5V_STBY through the resistor R9, and is coupled to a base of the transistor Q2 through the resistor R11. An anode of the diode D5 receives a power-on signal PS_ON from a motherboard 30. A cathode of the diode D5 is coupled to the base of the transistor Q2. An emitter of the transistor Q2 is connected to ground. A collector of the transistor Q2 is coupled to the system power terminal 5V_SYS through the resistor R10, and is connected to ground through the capacitor C1. The collector of the transistor Q2 is used to output a power good signal.

During a power-on operation, if one of the system power terminals 3V3, 5V_SYS, or 12V_SYS does not output a system voltage, one of the diodes D1, D2, or D3 is turned on. For example, if the system power terminal 3V3 does not output the system voltage, the diode D1 is turned on, and the stand-by power terminal 5V_STBY is connected to ground through the resistors R7 and R2 in that order. Resistances of the resistors R7 and R2 can be changed accordingly to make the base of the transistor Q1 be at a low-voltage level, such as logic 0, to make the transistor Q1 turn off, and the base of the transistor Q2 be at a high-voltage level, such as logic 1. At the same time, the system power terminals 5V_SYS and 12V_SYS output system voltages, and the diodes D2 and D3 are turned off, the power on signal PS_ON is at a low-voltage level during the power on operation, the diode D5 is turned off, and the base of the transistor Q2 is at a high-voltage level. Accordingly, the transistor Q2 is turned on, and the collector of the transistor Q2 outputs a low-voltage level power good signal.

During the power-on operation, when the system power terminals 3V3, 5V_SYS, and 12V_SYS all output system voltages, the diodes D1, D2, and D3 are turned off, and the base of the transistor Q1 is at the high-voltage level. Accordingly, the transistor Q1 is turned on, the collector of the transistor Q1 is at a low-voltage level, the base of the transistor Q2 is at the low-voltage level, and the transistor Q2 is turned off. The system power terminal 5V_SYS charges the capacitor C1 to delay for a predefined time duration. When the capacitor C1 is fully charged, the collector of the transistor Q2 outputs the high-voltage level power good signal.

When in a stand-by state, the power on signal PS_ON is at the high-voltage level. Thus, the diode D5 is turned on, and the transistor Q2 is turned on, making the collector of the transistor Q2 output a low-voltage level power good signal.

In the embodiment, the transistors Q1 and Q2 are npn-type transistors. In other embodiments, the transistors can be replaced by other electronic switches, such as metal-oxide semiconductor field-effect transistors.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A time sequence circuit, comprising:
a first, second, third, fourth, fifth, sixth, seventh, eighth, ninth, and tenth resistor;
a first and a second electronic switch each comprising a first, second, and third terminal;
a first, second, third, and fourth diode; and
a capacitor;
wherein a cathode of the first diode is coupled to a first power terminal through the first resistor, and is connected to ground through the second resistor; an anode of the first diode is coupled to a second power terminal through the third resistor, the anode of the first diode is coupled to the first terminal of the first electronic switch; a cathode of the second diode is coupled to a third power terminal through the fourth resistor, and is connected to ground through the fifth resistor; an anode of the second diode is coupled to the first terminal of the first electronic switch; a cathode of the third diode is coupled to a fourth power terminal through the sixth resistor, and is connected to ground through the seventh resistor; an anode of the third diode is coupled to the first terminal of the first electronic switch; the second terminal of the first electronic switch is connected to ground, the third terminal of the first electronic switch is coupled to the second power terminal through the eighth resistor, and is connected to the first terminal of the second electronic switch through the ninth resistor; the first terminal of the second electronic switch is coupled to a cathode of the fourth diode, an anode of the fourth diode receives a power on signal; the second terminal of the second electronic switch is connected to ground, the third terminal of the second electronic switch is coupled to the third power terminal through the tenth resistor, the third terminal of the second electronic switch is connected to ground through the capacitor, the third terminal of the second electronic switch is used to output a power good signal; when the first terminals of the first and second electronic switches are at low-voltage level, the first and second terminals of each electronic switch are disconnected from each other; when the first terminals of the first and second electronic switches are at high-voltage level, the first and second terminals of each electronic switch are connected to each other.

2. The time sequence circuit of claim 1, further comprising a fifth diode and an eleventh resistor, wherein an anode of the fifth diode is coupled to the anodes of the first, second, and third diodes, a cathode of the fifth diode is coupled to the first terminal of the first electronic switch, and the cathode of the fifth diode is connected to ground through the eleventh resistor.

3. The time sequence circuit of claim 2, wherein the first and second electronic switches are npn transistors, and the first terminals, second terminals, and the third terminals of the first and second electronic switches are bases, emitters, and collectors of the npn transistors, respectively.
